(19) United States
(12) Patent Application Publication
(10) Pub. No.: US 2021/0344989 A1
(43) Pub. Date: Nov. 4, 2021

(54) Crowdsourced Video Description via Secondary Alternative Audio Program

(71) Applicant: Gustavo Neiva De Medeiros, New York, NY (US)

(72) Inventor: Gustavo Neiva De Medeiros, New York, NY (US)

(21) Appl. No.: 17/284,204

(22) PCT Filed: Oct. 8, 2019
(86) PCT No.: PCT/US2019/055172

§ 371 Date: Apr. 9, 2021

Related U.S. Application Data
(60) Provisional application No. 62/744,800, filed on Oct. 12, 2018.

(51) Int. Cl. H04N 21/439; G06F 3/16; H04R 1/02; H04N 21/44; H04N 21/84; H04N 21/2187

(52) U.S. Cl. CPC H04N 21/439; G06F 3/165; H04R 1/028; H04R 2499/15; H04N 21/84; H04N 21/2187; H04N 21/44

(57) ABSTRACT

A system and method allow an operator to create user-generated audio which is livestreamed with a separate video to one or more users with little or no lag. The user-generated audio is second and alternate audio supplanting or replacing the original audio associated with the video. Using a mobile app, each user receiving the second alternate audio can play, pause, and/or replay the livestreamed second alternate audio.

### CROSS-REFERENCE TO RELATED APPLICATION

This application claims priority to U.S. Provisional Application No. 62/744,800, filed on Oct. 12, 2018, which is incorporated by reference in its entirety.

### FIELD

The present disclosure relates to audio transmissions and in particular to a system and method for providing user-generated audio and content to accompany video.

### BACKGROUND

Numerous audio systems in the prior art broadcast or otherwise transmit audio to users, sometimes alone as a single audio source without video, and other times with accompanying video in which the audio is synchronized with the video images. One example is television by which a television signal is transmitted to a television set with the video and the audio playing together.

However, traditional audio systems have a fixed audio content which cannot be altered, and so, for example, a viewer of a sports game on television can only hear commentary of the game in a fixed language instead of the language of the viewer. The only solution in the prior art is to separately obtain and turn on an alternate audio commentary in the viewer's language, and to play the alternate audio commentary along with the original video of the game but with the television sound turned down or off. Such a solution in the prior art is difficult to implement and requires a radio separate from a television yet operating both at the same time. In addition, the solution in the prior art cannot expand the alternate audio commentary to be implemented by the friends or family of the viewer, or otherwise by an audio commentator of the viewer's choice.

Another alternative is to turn down or turn off the television audio in a crowded noisy environment, such as in a sports bar, while still playing the television video, and then to obtain the missing audio via a mobile device. Such an alternative is implemented by the TUNITY™ service, such that the turned-down audio is replaced by the exact missing audio heard via a mobile device and optionally using earphones attached to the mobile device. However, TUNITY™ uses video detection to synchronize the audio, but uses the same audio feed as the broadcast audio. There is no option in TUNITY™ to replace the audio with alternate audio commentary or with audio in a different language.

A need exists for a service which provides alternate audio commentary and/or alternate languages along with its corresponding video. A need also exists for a service which provides alternate audio commentary by a commentator of the viewer's choice.

Other audio and media systems in the prior art do not present options for such alternate audio commentary or other features for listening to audio. For example, listeners of audio often desire the ability to pause or replay a continuous stream of audio, which broadcast media in the prior art cannot perform, especially if the audio stream is live.

Therefore, a need exists for a live audio stream which can be paused or replayed.

In addition, listeners often value and enjoy live streaming of audio in order to experience events such as a sport game in real-time. However, on-demand file serving cannot provide live streaming of audio, since entire blocks of files must be downloaded and/or buffered for on-demand file serving, thus causing a significant delay or lag in the transmission and streaming of audio. Similarly, podcasting involves downloading entire files such as audio files, which must also be buffered, causing a significant delay or lag.

Thus, a need exists for live audio streaming with insignificant or no delay.

Furthermore, a technique in the prior art known as video description is directed to inserting an audio or narrated description of key visual elements of programming to be within natural pauses in dialogue, with such insertion being performed by a broadcaster of a video. Thus, video description in the prior art makes television programs, feature films, and other media accessible to people who are blind or who have low vision, thereby creating a richer, more independent experience, such as describing key visual elements such as actions, facial expressions, costumes, or scene changes in a program that a blind or visually impaired viewer would otherwise miss. However, such video description in the prior art cannot present live audio since such descriptions of key visual elements are intentionally delayed for insertion into natural pauses in dialogue.

As such, a need exists for live audio streaming which is not delayed for insertion into natural pauses in dialogue.

Other technology in the prior art such as second audio program (SAP) technology broadcasts two different audio language programs with stereo television, as a dual-language service which originates from a broadcaster. However, SAP technology in the prior art is limited to two languages, such as typically English and Spanish when used in the Americas. Such SAP technology in the prior art also originates from the broadcaster as opposed to an alternate commentator selected by the viewer, such as user-generated audio.

As seen, a need exists for audio commentary in multiple languages which can be provided as user-generated audio.

Known social media websites and web services such as TWITTER™, PERISCOPE™, and FACEBOOK™ permit users to share content and comment on content in the form of commentary in discussion threads. However, such websites and web services do not permit user-generated audio which supplants the audio of a video stream.

A need exists for a system allowing user-generated audio which supplants the audio of a video stream.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A system and method allow an operator to create user-generated audio which is livestreamed with a separate video to one or more users with little or no lag. The user-generated audio is second and alternate audio supplanting or replacing the original audio associated with the video. Using a mobile app, each user receiving the second alternate audio can play, pause, and/or replay the livestreamed second alternate audio.

In one embodiment, the present invention is a system including: a display associated with a first user for displaying a first video to the first user without playing a first audio corresponding to the first video; and a user device associated with the first user which receives a second audio different from the first audio, the user device including: a speaker for outputting the second audio to the first user without playing the first audio to the first user. The user device includes the display. The user device is a mobile computing device. The second audio is livestreamed to the user device. The second audio is generated by an operator different from the first user. The first user includes a plurality of first users; and the second audio is broadcast to the plurality of first users. The system further includes a network for livestreaming the second audio to the user device. The user device includes a controller which allows the first user to control the playing of the video and the second audio. The user device includes a mobile app which, in conjunction with the controller, allows the first user to control the playing of the video and the second audio. The system further includes a transmitter for transmitting the second audio to the user device. The transmitter livestreams the second audio to the user device.

In another embodiment, the present invention is a system including: a display associated with a first user for displaying a first video to the first user without playing a first audio corresponding to the first video; a user device associated with the first user which receives a second audio different from the first audio, the user device including: a speaker for outputting the second audio to the first user while the first video is being displayed and without playing the first audio to the first user; and a transmitter for transmitting the second audio to the user device. The user device includes the display. The user device is a mobile computing device. The second audio is livestreamed to the user device. The second audio is generated by an operator different from the first user. The system further includes a network for livestreaming the second audio to the user device. The user device includes a controller which allows the first user to control the playing of the video and the second audio. The user device includes a mobile app which, in conjunction with the controller, allows the first user to control the playing of the video and the second audio.

In a further embodiment, the present invention is a method including receiving a first video along with a corresponding first audio; transmitting the first video to a user device without transmitting the first audio; receiving a second audio different from the first audio; transmitting the second audio to the user device; and playing the second audio with the first video.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of a system of the present invention;

FIG. 2 is a schematic of an alternative embodiment of the system of the present invention;

FIG. 3 is a schematic of a plurality of users serviced by the system of the present invention; and

FIG. 4 is a flowchart of a method of operation of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

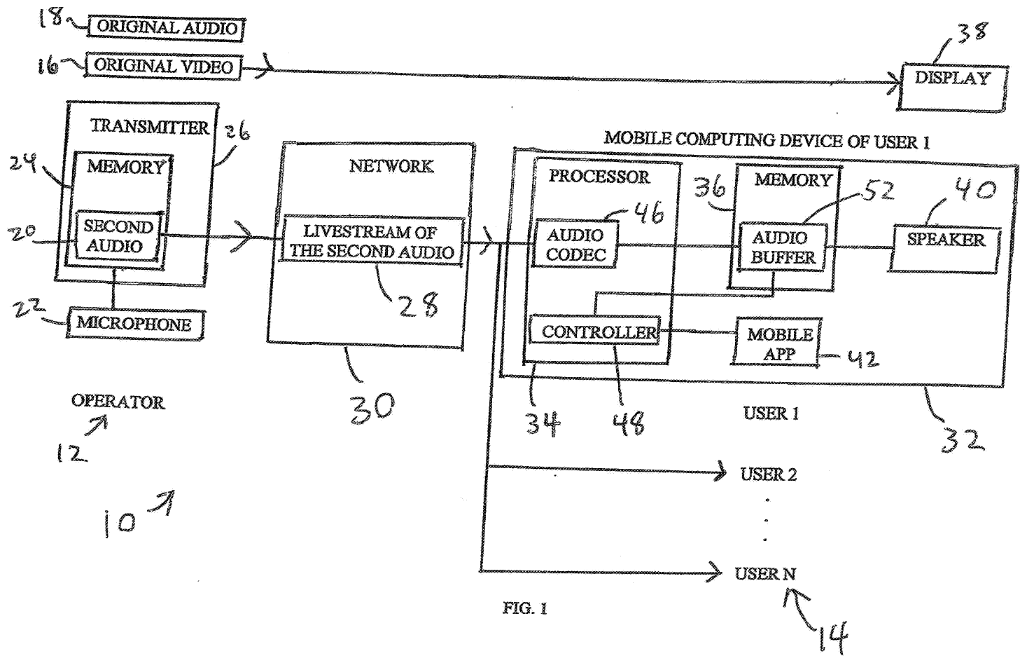

As shown in FIGS. 1-3, a system and method of the present invention permit an operator 12 to livestream audio, originating from the operator 12, to multiple users 14 such as User 1, User 2, etc. to User N.

Referring to FIG. 1, in the system 10, the original video 16 has associated original audio 18. However, although the original video 16 is provided to one or more of the multiple users 14, the original audio 18 may not be provided to the multiple users 14 and is not used by the system 10. Instead, the operator 12 generates second or alternate audio 20 using a microphone 22, with such second audio 20 stored in a memory 24 of a transmitter 26, and the second audio 20 is different from the original audio 18. For example, the operator 12 may generate the second audio 20 in a first language as user-generated audio from the operator 12, with the first language being different from the language of the original audio 18. In one example, the original audio 18 may be in English, but the second audio 20 may be in Spanish or any other known language different from English. Similarly, the operator 12 may generate the second audio 20 with a first commentary, such as describing a sports game, which may be different from any commentary of the original audio 18. Still further, the operator 12 may generate the second audio 20 with a first commentary which is the same or different from any commentary of the original audio 18, and also may generate the second audio 20 in another language which is different from the language of the original audio 18. In these examples and other possible examples, the operator 12 creates user-generated content in the second audio 20, which is distributed to multiple users 14.

In alternative embodiments, the operator 12 may generate the second audio 20 using electronic equipment and/or software known in the art instead of or in addition to the microphone 22. For example, the operator 12 may edit existing audio data using such known electronic equipment and/or software to generate the second audio 20. Such audio editing software may include the AUDACITY™ software application.

In addition, the memory 24 may be a temporary buffer for providing a livestream 28 of the second audio 20 with insignificant or no lag. The transmitter 26 may include a known interface or communication equipment for transmitting the second audio 20. For example, the transmitter 26 may be an Ethernet-based network card or board operatively connected to the network 30. Furthermore, the transmitter 26 may be a mobile phone associated with the operator 12, or alternatively an online radio station, any of which transmits the livestream 28 of the second audio to a network 30 for distribution or for other known methods of access to any or all of the multiple users 14, such as to a mobile computing device 32 of User 1. In another alternative embodiment, the transmitter 26 may include a tricaster, with one example being the TRICASTER 8000™, available from VARTO TECHNOLOGIES™.

The original video 16 is sent directly to a display 38, which may be a television or any known display device viewable by the users 14. Alternatively, the original video 16 is also distributed via the network 30 to any or all of the multiple users 14, such as to the mobile computing device 32 associated with User 1. The network 30 may be the Internet and/or a local network, or may be any type of network known in the art.

Each of the users 14 may have a respective mobile computing device, such as the mobile computing device 32 of User 1, which may be embodied by any known mobile device such as a mobile phone, a tablet, or a smart phone. For example, the mobile computing device 32 has a processor 34, a memory 36, a speaker 40, and a mobile app 42. The processor 34 may be an APPLE™ A13 microprocessor, a HUAWEI™ KIRIN 990 microprocessor, a QUALCOMM™ SNAPDRAGON 855 PLUS microprocessor, or a SAMSUNG™ EXYNOS 9820 microprocessor, or may be any other known type of microprocessor.

The processor 34 has an audio codec 46 and a controller 48. The audio codec 46 may include a speech-based codec such as ACELP.net, which is a general speech codec available through VOICEAGE™. Other audio/speech codecs may be used, such as MP3, AAC, FLAC, OGG, and WMA, as well as open source codecs such as SPEEX and OPUS. The memory 36 has an audio buffer 52. The mobile computing device 32 also includes a mobile app or application 42, which may be software executed by the processor 34 and/or software residing in the memory 36. The software may be written in the PYTHON, ERLANG, C, C++, C#, JAVA, JAVASCRIPT, PHP and/or RUBY programming languages.

The mobile app 42 is capable of controlling the playing of the livestream 28 of the second audio 20 by the mobile computing device 32. The mobile app 42 may be a live audio streaming app capable of running on ANDROID™, iOS™, or other operating systems and Internet-connected devices that provides user-generated audio and social networking content with which users talk and interact. The system 10 thus transmits, by broadcasting or otherwise, live audio generated by and for end users, predominantly on their mobile computing devices 32, such as mobile phones, tablets, and smart phones.

In operation, the system 10 of the present invention has the original video 16 transmitted to the display 38. However, the original audio 18 is optionally not received and/or not processed by the display 38. Alternatively, the original audio 18 may be received by display 18, but any speaker associated with the display 38 may have its volume reduced or muted.

Instead of the original audio 18, the users 14 have access to and receive the second audio 20, such that the livestream 28 of the second audio 20 is received and processed by the audio codec 46 via the network 30. Internet streaming radio technology, known in the art, is used to distribute Internet radio, typically using a lossy audio codec. Streaming audio formats include MP3, Ogg Vorbis, WINDOWS™ Media Audio, RealAudio, and HE-AAC or aacPlus. Audio data is continuously transmitted serially; that is, streamed over the local network or the Internet in TCP or UDP packets, then reassembled at the mobile computing device 32 as the receiver, and played a second or two later, with little or no lag. Alternatively, the livestreamed second audio 28 may be temporarily stored in the audio buffer 52, and then sent to the speaker 40 to be played concurrently and optionally in synchronization with the original video 16 shown on the display 38. Therefore, User 1 views the original video 16 in conjunction with the second audio, thus providing a second alternative audio for the original video 16, to permit alternative commentary to the original video. For example, the second audio 20 may be in a spoken language different from the spoken language of the original audio 18 and/or with commentary in the second audio 20 different from any commentary in the original audio 18.

The mobile app 42 allows the user of the mobile computing device 32, such as User 1, to control the operations of the mobile computing device 32 with respect to the livestream 28 of the second audio 20. For example, the mobile app 42 may control the controller 48 which, in turn, controls the audio buffer 52 to play the second audio 20 from the livestream 28. For example, the controller 48 may be controlled using buttons on the mobile computing device 32 and/or using icons or other actuatable display regions in a graphical user interface (GUI) displayed by the mobile app 42 on a display or screen of the mobile computing device 32, or otherwise on a display or screen, such as the display 38, associated with the mobile computing device 32. In addition, the controller 48 may allow the user, using the mobile app 42, to control the audio buffer 52 to pause or to replay the second audio 20 from the livestream 28. That is, the user is provided with the ability to manually synchronize the second audio 20 with the original video 16.

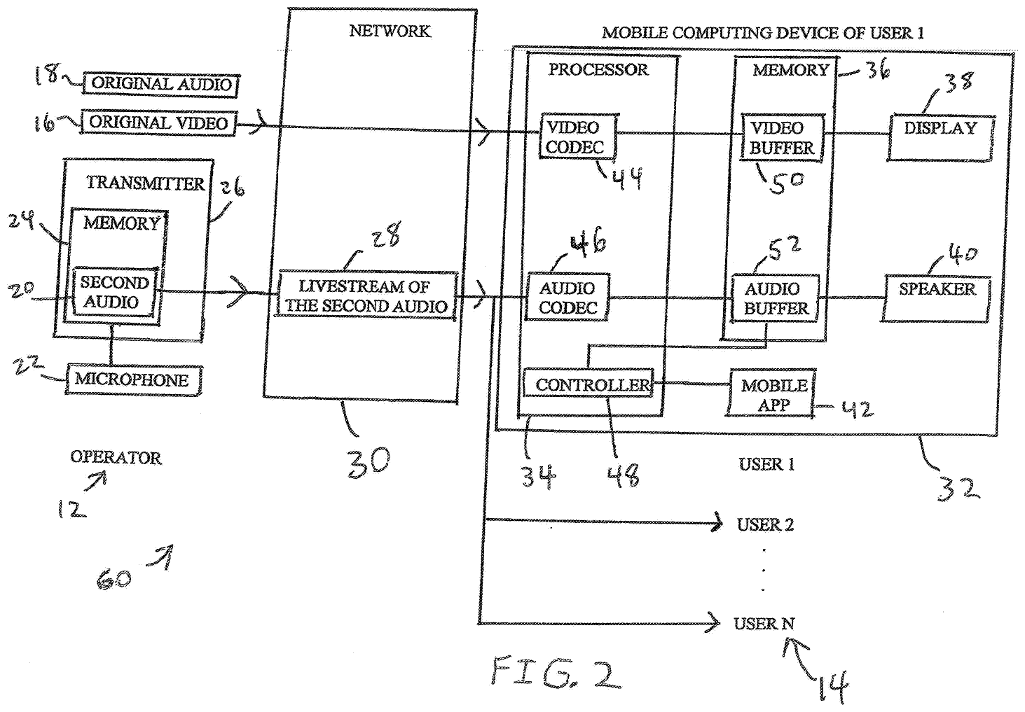

Referring to FIG. 2, in an alternative embodiment, the system 60 has the original video 16 with its associated original audio 18. However, although the original video 16 is provided to a display 38 of a mobile computing device 32 of each of one or more of the multiple users 14, the original audio 18 is not provided to the multiple users 14 and is not used by the system 60. Instead, the operator 12 generates second or alternate audio 20 using a microphone 22, with such second audio 20 stored in a memory 24 of a transmitter 26. In this embodiment, the user is provided with the ability to watch the original video 16 and listen to the second or alternate audio 20 on the same device, e.g., a mobile device, by simultaneously running multiple apps or programs 42, i.e., a broadcast app for the original video 16 and an app for the second audio 20, on the same device. In alternative embodiments, the operator 12 may generate the second audio 20 using electronic equipment known in the art instead of or in addition to the microphone 22. For example, the operator 12 may edit existing audio data to generate the second audio 20, as described above.

In addition, the memory 24 may be a temporary buffer for providing a livestream 28 of the second audio 20 with insignificant or no lag. Furthermore, the transmitter 26 may be a mobile phone associated with the operator 12, or alternatively an online radio station, any of which transmits the livestream 28 of the second audio to a network 30 for distribution or for other known methods of access to any or all of the multiple users 14, such as to a mobile computing device 32 of User 1. The original video 16 is also distributed via the network 30 to any or all of the multiple users 14, such as to the mobile computing device 32 associated with User 1. The network 30 may be the Internet and/or a local network, or may be any type of network known in the art.

Each of the users 14 may have a respective mobile computing device, such as the mobile computing device 32 of User 1, which may be embodied by any known mobile devices such as a mobile phone, a tablet, or a smart phone. For example, the mobile computing device 32 has a processor 34, a memory 36, a display 38, a speaker 40, and a mobile app 42. The processor 34 has a video codec 44, an audio codec 46, and a controller 48. The video codec 44 may be an MPEG-based video codec, as well as H.264/AVC, H265/HEVC, VP8, VP9, DIRAC, AV1, AAC, VC1, and VVC. Also, the audio codec 46 may be as described above.

The memory 36 has a video buffer 50 and an audio buffer 52. The mobile computing device 32 also includes a mobile app or application 42, which may be software executed by the processor 34 and/or software residing in the memory 36. The software may be written in the JAVASCRIPT, C++, or C# programming languages. The mobile app 42 is capable of controlling the playing of the livestream 28 of the second audio 20 by the mobile computing device 32. The mobile app 42 may be a live audio streaming app capable of running on ANDROID™, iOS™, or other operating systems and Internet-connected devices that provides user-generated audio and social networking content with which users talk and interact. The system 60 thus transmits, by broadcasting or otherwise, live audio generated by and for end users, predominantly on their mobile computing devices 32, such as mobile phones, tablets, and smart phones.

In operation, the system 60 of the present invention has the original video 16 transmitted to the mobile computing device 32 via the network 30, to be received and processed by the video codec 44, to then be temporarily stored in the video buffer 50 and sent to be displayed and shown to User 1 on the display 38. However, the original audio 18 is not received and/or not processed by the mobile computing device 32. Alternatively, the original audio 18 may be received by the mobile computing device 32 but may be left unprocessed by the processor 34 and/or not saved in the memory 36.

Instead, the livestream 28 of the second audio 20 is received via the network 30 and processed by the audio codec 46. Internet streaming radio technology, known in the art, is used to distribute Internet radio, typically using a lossy audio codec. Streaming audio formats include MP3, Ogg Vorbis, WINDOWS™ Media Audio, RealAudio, and HE-AAC or aacPlus. Audio data is continuously transmitted serially; that is, streamed over the local network or the Internet in TCP or UDP packets, then reassembled at the mobile computing device 32 as the receiver, and played a second or two later, with little or no lag. Alternatively, the livestreamed second audio 28 may be temporarily stored in the audio buffer 52, and then sent to the speaker 40 to be played concurrently and in synchronization with the original video 16. Therefore, User 1 views the original video 16 in conjunction with the second audio, thus providing a second alternative audio for the original video 16, to permit alternative commentary to the original video. For example, the second audio 20 may be in a spoken language different from the spoken language of the original audio 18.

The mobile app 42 allows the user of the mobile computing device 32, such as User 1, to control the operations of the mobile computing device 32 with respect to the livestream 28 of the second audio 20. For example, the mobile app 42 may control the controller 48 which, in turn, controls the audio buffer 52 to play the second audio 20 from the livestream 28. For example, the controller 48 may be controlled using buttons on the mobile computing device 32 and/or using icons or other display regions in a graphical user interface (GUI) displayed by the mobile app 42 on a display or screen of the mobile computing device, or otherwise on a display or screen, such as the display 38, associated with the mobile computing device 32. In addition, the controller 48 may allow the user, using the mobile app 42, to control the audio buffer 52 to pause or to replay the second audio 20 from the livestream 28. That is, the user is provided with the ability to manually synchronize the second audio 20 with the original video 16.

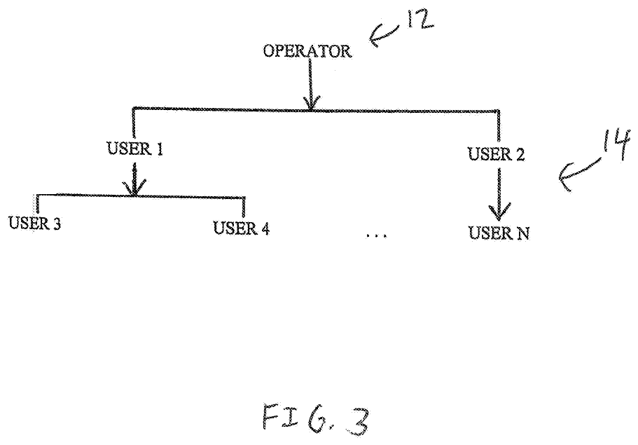

As shown in FIG. 3, the operator 12 of either of the systems 10, 60 may transmit the second audio 20, such as user-generated audio, to multiple users 14 such as User 1, User 2, etc. to User N. Alternatively, the user-generated audio may be sent from the operator 12 to User 1, who may in turn simply relay the user-generated audio to User 3 and User 4, while User 2 may in turn simply relay the user-generated audio to User N. Such distribution of user-generated audio is peer-to-peer audio distribution, using a peer-assisted content delivery network (CDN) technology and methods known in the art.

In an alternative embodiment, each user receiving a user-generated audio may modify the user-generated audio to generate new user-generated audio for distribution. For example, referring again to FIG. 3, the operator 12 may generate the second audio in a first language as user-generated audio from the operator 12, and User 1 may modify the second audio to be in a second language for distribution to User 3 and User 4. Similarly, the operator 12 may generate the second audio with a first commentary, such as describing a sports game, which is then received by User 2, and User 2 may then modify the second audio from the operator 12 to be, instead, a second commentary describing the sports game from the perspective of User 2, and User 2 may then distribute the second commentary to User N.

Using the systems 10, 60, since an Internet protocol may be used for the network 30, each operator 12 is able to reach a wide audience of users 14, and become a crowd-based audio presenter, a personality, a disk jockey (DJ), a video jockey (VJ), a media host, a comedian, a social commentator, etc. For example, the operator 12 may simply talk on his/her mobile phone or may use a more professional base station, and may provide commentary or alternate language translations while watching a video on TV or at a live event broadcast, for example, by a television station, and so the commentary or translation of the operator 12 may be received by one or more of the users 14 who are also tuned in to the same television station as the operator 12 to watch the same video in conjunction with the commentary or translation of the operator 12. Such crowd-based audio presenters can from a community providing crowdsourced content such as crowdsourced video descriptions using the second or alternative audio described above.

In conjunction with the mobile app 42, the systems 10, 60 have all the features necessary to do interviews, pay for ads, play music, and synchronize with TV programs. The mobile app 42 empowers anyone with a mobile phone to offer news, sports, talk shows, and various genres of music, and in particular every format that is available on traditional broadcast radio stations. There are no significant start-up or ongoing costs, besides costs, for example, for a telephone, as the transmitter 26, as well as network access to the network 30, such as Internet access. Hence, the mobile app 42 facilitates tremendous proliferation of independent Internet-only type radio stations. For example, referring to FIG. 3, operators 12 and/or users 14 of the service provided by the systems 10, 60 are able to choose whether or not to make their audio public or simply viewable to certain users such as their friends or families. Operators 12 and users 14 are able to offer subscriptions to their service or charge for one-off events. Operators 12 and users can choose whether to save their transmissions of second audio 20 in the memories 24, 36, respectively, or to delete them at any time, or at a default time such as after 24 hours.

The system 60 and/or the mobile app 42 may be used as a companion app also known as a second screen. A second screen involves the use of a computing device, commonly a mobile device, such as a smartphone or tablet, to provide an enhanced viewing experience for content on another device, such as a television. In the case of the present invention, the second screen provides a secondary audio source that can function as the primary audio source. In particular, a second screen commonly refers to the use of such devices to provide interactive features during broadcast content, such as a television program, especially social media postings on social networking platforms, such as FACEBOOK™ and TWITTER™. Instead of social media postings, the systems 10, 60, using the mobile app 42, provide live user-generated audio, which is designed not only to keep an audience engaged in whatever they are involved in, but more importantly, to give them freedom of hearing by separating audio and video. The use of the systems 10, 60 supports social television and generates an online conversation in speech and sound around the specific content.

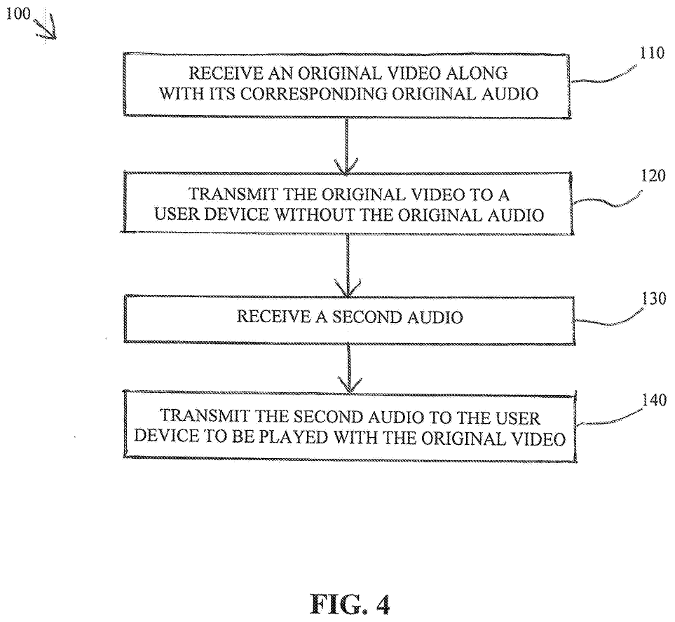

In use, the system 10, 60 of the present invention may operate according to the method 100 shown in FIG. 4, which includes the steps of receiving the original video 16 along with its corresponding original audio 18 in step 110; transmitting the original video to a user device, such as the mobile computing device 32 of User 1, without transmitting the original audio in step 120; receiving the second audio 20 in step 130 which is different from the original audio 18; and transmitting the second audio 20 to the user device to be played with the original video 16 in step 140.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

1. A system comprising:
a display associated with a first user for displaying a first video to the first user without playing a first audio corresponding to the first video; and
a user device associated with the first user which receives a second audio different from the first audio, the user device including:
a speaker for outputting the second audio to the first user without playing the first audio to the first user;
wherein the second audio is generated by an operator different from the first user.

2. (canceled)

3. (canceled)

4. The system of claim 1, wherein the second audio is livestreamed to the user device.

5. (canceled)

6. The system of claim 1, wherein the first user includes a plurality of first users; and
wherein the second audio is broadcast to the plurality of first users.

7. The system of claim 1, further comprising:
a network for livestreaming the second audio to the user device.

8. The system of claim 1, wherein the user device includes a controller which allows the first user to control the playing of the video and the second audio.

9. The system of claim 8, wherein the user device includes a mobile app which, in conjunction with the controller, allows the first user to control the playing of the video and the second audio.

10. The system of claim 1, further comprising:
a transmitter for transmitting the second audio to the user device.

11. The system of claim 10, wherein the transmitter livestreams the second audio to the user device.

12. A system comprising:
a display associated with a first user for displaying a first video to the first user without playing a first audio corresponding to the first video;
a user device associated with the first user which receives a second audio different from the first audio, the user device including:
a speaker for outputting the second audio to the first user while the first video is being displayed and without playing the first audio to the first user; and
a transmitter for transmitting the second audio to the user device;
wherein the second audio is generated by an operator different from the first user.

13. (canceled)

14. (canceled)

15. The system of claim 12, wherein the second audio is livestreamed to the user device.

16. (canceled)

17. The system of claim 12, further comprising:
a network for livestreaming the second audio to the user device.

18. The system of claim 12, wherein the user device includes a controller which allows the first user to control the playing of the video and the second audio.

19. The system of claim 18, wherein the user device includes a mobile app which, in conjunction with the controller, allows the first user to control the playing of the video and the second audio.

20. A method comprising:
an operator receiving a first video along with a corresponding first audio;
the operator generating a second audio different from the first audio and transmitting the second audio and first video to a user device of a first user without transmitting the first audio;
the first user receiving the second audio and the first video; and
the first user broadcasting the second audio and the first video to a plurality of second users.

21. The system of claim 1, wherein the second audio is further modified by the first user to generate a third audio, where in the third audio is broadcast to a plurality of second users.

22. The system of claim 6, wherein at least one of the plurality of first users broadcasts the second audio to a plurality of second users.

23. The system of claim 12, wherein the second audio is further modified by the first user to generate a third audio, wherein the third audio is broadcast to a plurality of second users.

24. The system of claim 12, wherein the first user broadcasts the second audio to a plurality of second users.

25. The method of claim 20 further comprising the step of:
prior to the first user broadcasting the second audio and the first video to the plurality of second users, a third audio is generated by the first user and broadcast with the second audio to a plurality of second users.

26. The method of claim 25, wherein the plurality of second users are within a peer-to-peer group determined by the first user.
